(19) United States
(12) Patent Application Publication
(10) Pub. No.: US 2010/0282093 A1
(43) Pub. Date: Nov. 11, 2010

(54) LIFTING MECHANISM OF GRILL

(75) Inventors: Hwai-Hsiang KUO, Tainan County (TW); Yang Zhou, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangshou) Enterprise Co., Ltd., Fujian Province (CN)

(21) Appl. No.: 12/776,707

(22) Filed: May 10, 2010

(30) Foreign Application Priority Data
May 9, 2009 (CN) 200920138273.7

(51) Int. Cl. A47J 37/06

(52) U.S. Cl. 99/379

(57) ABSTRACT

The lifting mechanism of a grill has an articulated lifting shaft attached to the edge of an upper shell, so that it covers the shaft sleeve. The shaft sleeve is connected to the corresponding edge of a lower shell and an inserting portion which extends along radius is provided on the shaft sleeve. The inserting portion slideably inserts into a sliding sleeve set on the edge of the lower shell and a stop-motion unit prevents the inserting portion from sliding. When the stop-motion unit takes effect, the inserting portion is fixed in the sliding sleeve, and the upper shell can only rotate relative to the lower shell. Food is tightly sandwiched between the upper grill pan and the lower grill pan during baking. Otherwise, the inserting portion is slidable in the sliding sleeve. The upper shell can be freely lifted during baking, and rotate relative to the lower shell.

### FIELD OF THE INVENTION

The present utility model relates to an articulated unit of grill, especially to an articulated unit of grill having lifting articulated shaft.

### BACKGROUND OF THE INVENTION

To make the upper shell of grill rotated relative to the lower shell in order to add the food or remove food on/from the lower grill pan; the articulated shaft is provided between the edges of the upper shell and the lower shell. The two ends of articulated shaft are respectively provided on an edge of the upper shell, the middle portion of said articulated shaft covers the shaft sleeve, said shaft sleeve is connected with the is corresponding edge of the lower shell. Since the position of articulated shaft is fixed relative to the upper shell and the lower shell, when grill the food like the sandwich that should be sandwiched tightly, only press the upper shell, the food can be tightly sandwiched between the upper grill pan and the lower grill pan; when grill the food that can not be sandwiched tightly, the articulated shaft can be changed relative to the lower grill pan, and this structure of articulated shaft can not meet the requirement.

### SUMMARY OF THE INVENTION

The present utility model is to provide a lifting mechanism of grill, to enable the upper grill pan and the lower grill pan press the food tightly or enable the upper grill pan lift relative to the lower grill pan, to satisfy the requirements of baking different foods.

The technical proposal of present utility model is: a lo lifting mechanism of grill, an articulated shaft is provided on edge of a upper shell, said articulated shaft covers a shaft sleeve, said shaft sleeve is connected with corresponding edge of a lower shell ; an inserting portion which extends along radius is provided on said shaft sleeve; said inserting portion is slideably inserts into a sliding sleeve, a stop-motion unit preventing said inserting portion from sliding is provided on said inserting portion; said sliding sleeve is set on edge of the lower shell. When the stop-motion unit takes effect, the inserting portion is fixed in the sliding sleeve, the position of the articulated shaft is fixed, the upper shell only can rotates relative to the lower shell, food like sandwich is tightly sandwiched between the upper grill pan and the lower grill pan in baking process. When the stop-Motion unit does not take effect, the inserting portion is slidable in the sliding sleeve. The articulated shaft can freely lift, the upper shell s not only can rotates relative to the lower shell, but also can freely lift in baking process, satisfy the requirement for baking food like waffle cake.

Said stop-motion unit of the inserting portion is a stop-motion bore which faces the lower grill pan, a corresponding stop-motion rib of the lower grill pan detachly inserts into said stop-motion bore.

An inserting bore corresponding to the stop-motion bore of the inserting portion is provided on said sliding sleeve.

A limiting component which limits the slide field of the inserting portion is provided between the said inserting portion and the sliding sleeve.

Said limiting component comprising: a limiting groove positioned on the side wall of the sliding sleeve; a limiting sheet positioned on the inserting portion, said limiting sheet slideably inserts into the limiting groove of the sliding sleeve.

A fixing tube and a fixing plate of the raised orientation line are provided on the middle of the sliding sleeve.

The lifting mechanism of present utility model, an inserting portion which extends along radius and has a stop-motion unit is provided on said shaft sleeve; said inserting portion slideably inserts into a sliding sleeve, said sliding sleeve is set on edge of the lower shell. When the stop-motion unit takes effect, the inserting portion is fixed in the sliding sleeve, the upper shell only can rotates relative to the lower shell, food is tightly sandwiched between the upper grill pan and the lower grill pan in baking process. When the stop-motion unit does not take effect, the inserting portion is slidable in the sliding sleeve. The upper shell not only can rotate relative to the lower shell, but also can freely lift in baking process. The stop-motion unit of the inserting portion adopts the bores, when the stop-motion rib of the lower grill pan inserts into said stop-motion bore, the inserting portion is fixed; the structure of stop-motion is simple, and easy for operation of stop-motion, convenient for using different lower grill pans. The inserting bore corresponding to stop-motion bore of the inserting portion is provided on the sliding sleeve, this double inserting bores use the sliding sleeve set on edge of the lower shell, the stop-motion effect is good and the mechanical strength is high. The limiting component which limits the slide field of the inserting portion is provided between the said inserting portion and the sliding sleeve, it is smoothly and safety for operation. Said limiting component comprising: a limiting groove positioned on the side wall of the sliding sleeve; a limiting sheet positioned on the inserting portion, said limiting sheet slideably inserts into the limiting groove of the sliding sleeve. This limiting component has simple structure, lo high reliability. A fixing tube and a fixing plate of the raised orientation line are provided on the middle of the sliding sleeve. Said fixing tube match the upper shell, for orientating sliding sleeve, raised orientation line is used for orientating the lower grill pan.

### BRIEF DESCRIPTION OF THE DRAWINGS

FIG. 1 is an explosion diagram of one embodiment of the lifting mechanism of grill in present utility model.

FIG. 2 is a bottom view of FIG. 1.

FIG. 3 is a three-dimensional diagram of embodiment of FIG. 1 without articulated shaft in convention state.

FIG. 4 is a three-dimensional diagram of embodiment of FIG. 1 without articulated shaft in lifting state.

FIG. 5 is an explosion diagram of a grill adopting the embodiment of FIG. 1.

FIG. 6 is a three-dimensional diagram of the lower grill pan of the grill of FIG. 5.

FIG. 7 is a sectional view of the connection between the shaft seat and the lifting mechanism of the grill of FIG. 5.

FIG. 8 is a three-dimensional diagram of the grill of FIG. 5 when the upper grill pan is in fall state.

FIG. 9 is a three-dimensional diagram of the grill of FIG. 5 when the upper grill pan is in rising state.

### DESCRIPTION OF SPECIFIC EMBODIMENT

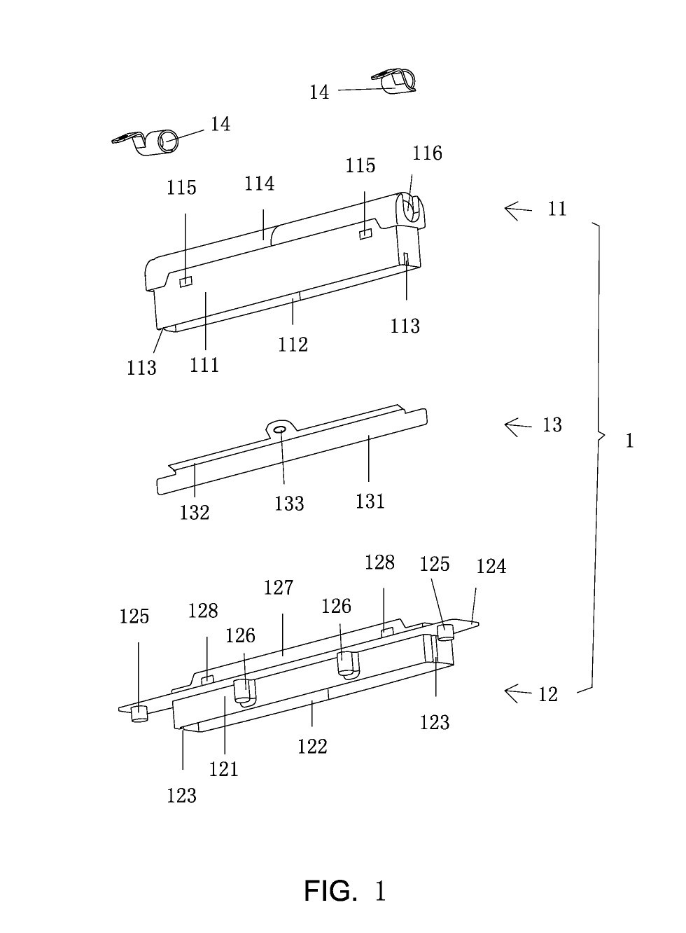

Referring to FIG. 1, it is an explosion structure of one embodiment of the lifting mechanism of grill in present utility model. The lifting mechanism of the grill comprising: a shaft sleeve 11, a sliding sleeve 12, a limiting sheet 13, an articulated shaft 14.

A rectangular inserting portion 111 which extends along radius is provided on said shaft sleeve 11. Four side walls of the rectangular inserting portion 111 surround the inner groove 112 which is hollow. An inserting groove 113 is respectively provided on the short side walls of the rectangular inserting portion 111. A stop-motion bore 115 is respectively provided on the long side walls of the rectangular inserting portion 111. the upper of the rectangular inserting portion 111 is a main body 114 of the shaft sleeve, the size of the main body 114 of the shaft sleeve is bigger than the rectangular inserting portion 111, the shaft bores 116 which go through the two ends are provided on the main body 114 of the shaft sleeve. Two portions of articulated shaft 14 respectively insert into the shaft bores 116 of the main body 114 of the shaft sleeve and connect with the edge of the upper shell

The main body 121 of the sliding sleeve 12 is rectangle-tubular, four side walls surround the inner bore 122. Said inner bore 122 slideably holds the rectangular inserting portion 111 of the shaft sleeve 11 but prevents the main body 114 of the shaft sleeve 11 from going into the inner bore 122. A limiting groove 123 is respectively provided on the short side walls of the main body 121 of the sliding sleeve 12. The width of the limiting groove 123 equals to the width of the inserting groove 113 of the inserting portion 111. A fixing plate 124 is provided on the middle of the main body 121 of the sliding sleeve 12, which is corresponding to the bottom of the limiting groove 123, a fixing tube 125 extending downwardly is respectively provided on the two ends of the fixing plate 124. Two raised orientation lines are provided on the fixing plate 124 and the long side wall of the main body 121 facing to the lower grill pan. The upper portion of the main body 121 of the sliding sleeve 12 goes beyond the protruding portion 127 of the fixing plate 124, an inserting bore 128 is respectively provided on the protruding portion 127, each inserting bore 128 has the same size and position as the corresponding stop-motion bore 115 of the rectangular inserting portion 111 of the shaft sleeve 11.

The main body 131 of the limiting sheet 13 is a bar-shaped thin plate, the length of the main body 131 is longer than the length of the sliding sleeve 12, the thickness of the main body 131 is thinner than the width of the inserting groove 113 of the rectangular inserting portion 111 and the width of the limiting groove 123 of the sliding sleeve 12. A buckling unit 132 is formed on the long side wall of the main body 131, a protruding portion 133 having a bore are extended from the middle of the buckling unit 132; the length of the buckling unit 132 is shorter than the length of the inner groove 112 of the rectangular inserting portion 111, the width of the buckling unit 132 and the width of the protruding portion 133 are shorter than the width of the inner groove 112.

The articulated shaft 14 is divided into two portions, each portion has a short circular duct and a fin turning outwardly, the fin having a bore for fixing by the insertion of screw.

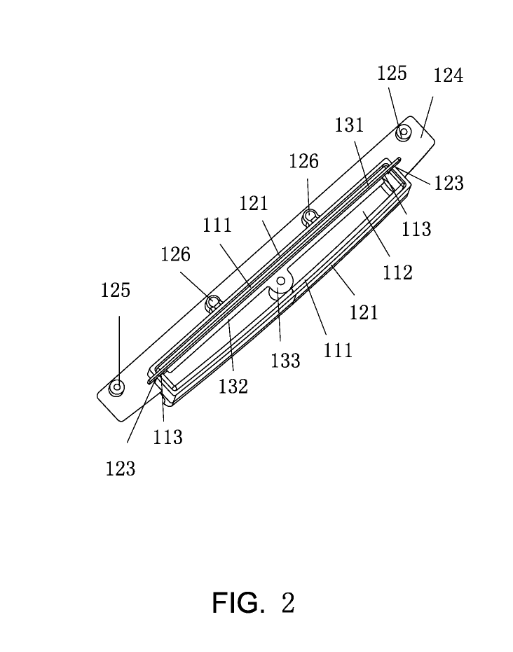

After assembly, the rectangular inserting portion 111 of the shaft sleeve 11 slideably inserts into the inner bore 122 of the main body 121 of the sliding sleeve 12. Referring to FIG. 2, the buckling unit 132 of the limiting sheet 13 and the protruding portion 133 are put into the inner groove 112 of the rectangular inserting portion 111 of the shaft sleeve 11, the two ends of the main body 131 of the limiting sheet 13 slideably insert into the limiting groove 123 of the main body 121 of the sliding sleeve 12 and the inserting groove 113 of the rectangular inserting portion 111 of the shaft sleeve 11, a screw goes through the bore of the protruding portion 133 of the limiting sheet 13 and is fixed on the bottom of the inner groove 112 of the rectangular inserting portion 111 of the shaft sleeve 11, the limiting sheet 13 is fixed with the shaft sleeve 11. The short circular duct inserts into the shaft bore 116 of the shaft sleeve 11, the fin is respectively connected with the edge of the upper shell.

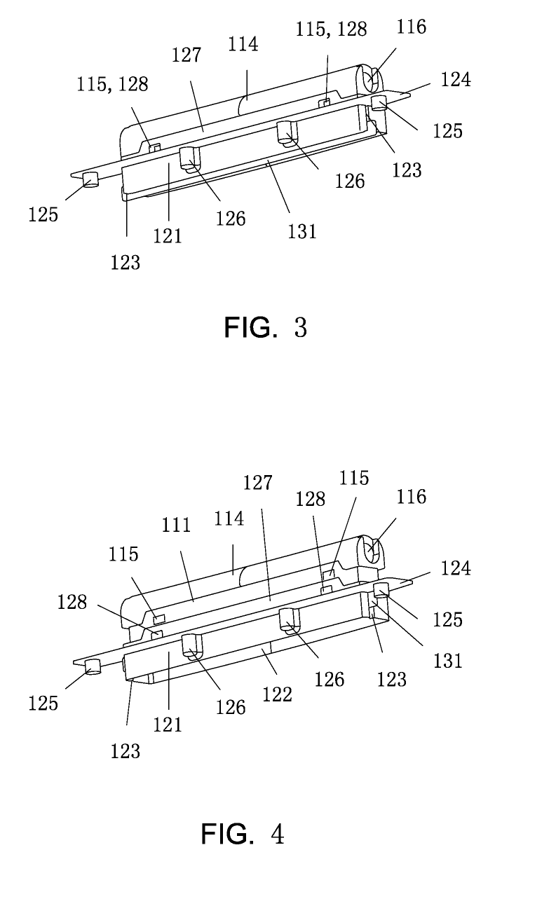

Referring to FIG. 3: when the rectangular inserting portion 111 of the shaft sleeve 11 inserts completely into the inner bore 122 of the main body 121 of the sliding sleeve 12, the stop-motion bore 115 is aligned with the corresponding inserting bore 128; the main body 131 of the limiting sheet 13 is positioned on the opening of the limiting groove 123 of the main body 121 of the sliding sleeve 12. When the stop-motion ribs of the lower grill pan insert into the stop-motion bores 115 and the inserting bores 128, the rectangular inserting portion 111 of the shaft sleeve 11 is fixed in the inner bore 122 of the sliding sleeve 12; the articulated shaft 14 of the main body 114 of the shaft sleeve 11 is fixed.

Referring to FIG. 4, when the stop-motion ribs of the lower grill pan do not insert into the stop-motion bores 115, the rectangular inserting portion 111 of the shaft sleeve 11 is slidable in the inner bore 122 of the main body 121 of the sliding sleeve 12, the stop-motion bore 115 is not aligned with the corresponding inserting bore 128, when the main body 131 of the limiting sheet 13 reach the bottom of the limiting groove 123 of the main body 121 of the sliding sleeve 12, the limiting sheet 13 stops the shaft sleeve 11 going upwardly, the slide field of the articulated shaft 14 is limited by the slide field of the limiting sheet 13.

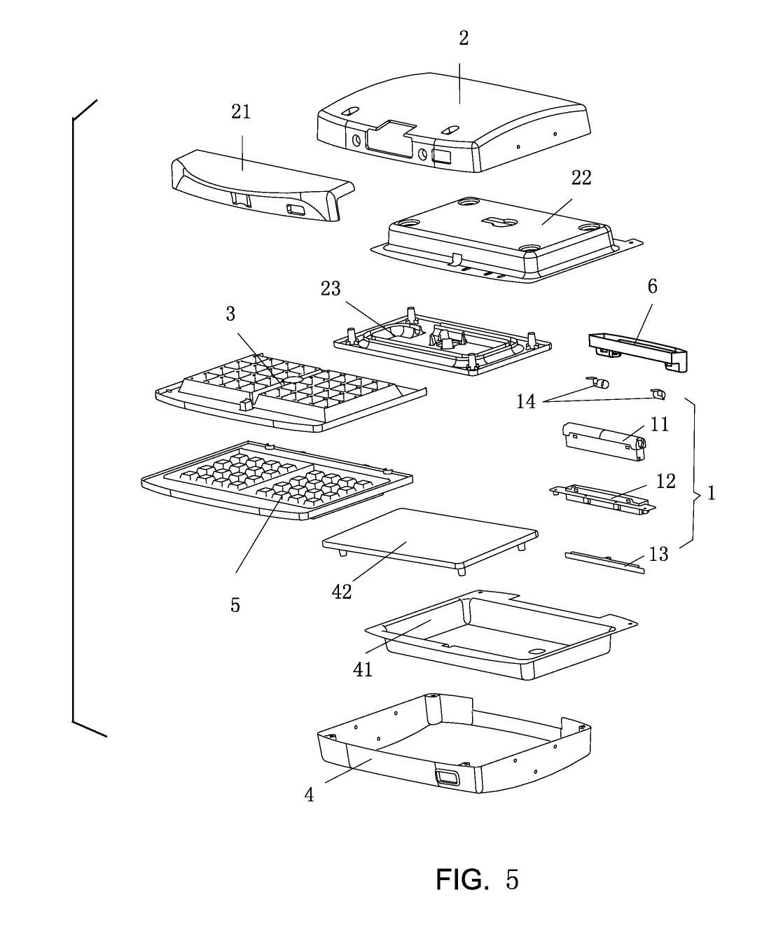

Referring to FIG. 5, the components of the grill adopting above-mentioned lifting mechanism. The grill comprising: a lifting mechanism 1, a upper shell 2, a faceshield 21, a upper heat insulation pan 22, a upper heating pan 23, a upper grill pan 3, a lower shell 4, a lower heat insulation pan 41, a lower heating pan 42, a lower grill pan 5, a shaft base 6.

The faceshield 21 is provided on the front of the upper shell 2. The upper heat insulation pan 22 is set inner of the upper shell 2; a upper heating pan 23 having electric heater is set in the upper heat insulation pan 22. A upper grill pan 3 is fixed on the upper heating pan 23. A lower heat insulation pan 41 is provided in the lower shell 4; a lower heating pan 42 having electric heater is set in the lower heat insulation pan 42. A lower grill pan 5 is provided on the lower heating pan 42.

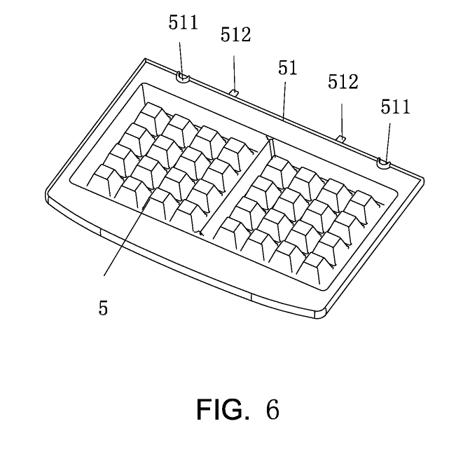

Referring to FIG. 6, two semicircular grooves 511 are provided on the rear edge 51 of the lower grill pan 5, these grooves 511 leave the space for the fixing tube 125 of the sliding sleeve 12. two stop-motion ribs 512 extending backwardly are provided on the rear edge of the lower grill pan 5, the stop-motion ribs 512 have inserting structure with the stop-motion bores 115. Two orientation grooves are provided the rear edge 51 of the lower grill pan 5, these two orientation grooves leave the space for the raised orientation line 126.

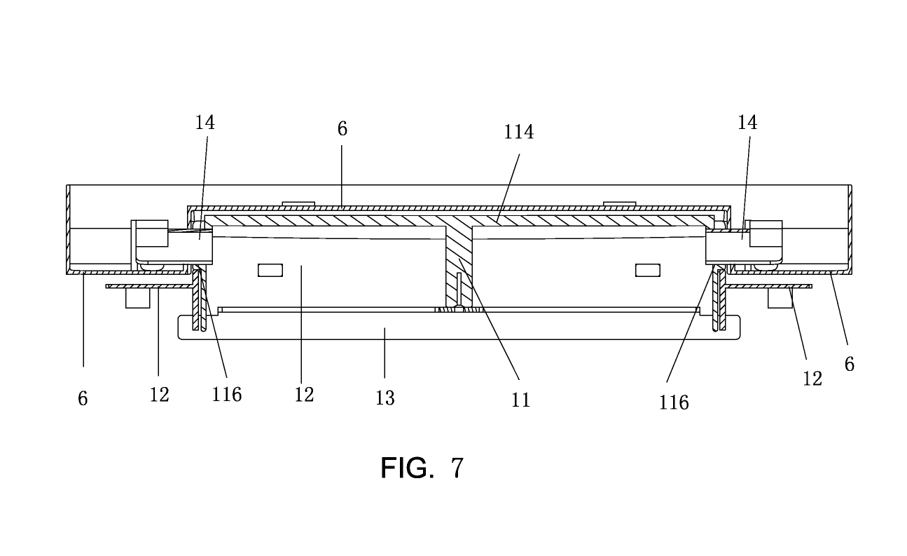

Referring to FIG. 7, the main body of the shaft base 6 is bar-shaped case, the two ends of bottom of the case extends downwardly along the length and form two concave portions; the shaft bore is respectively provided on the side wall of the opening of the lower of the shaft base 6. the main body 114 of the shaft sleeve 11 inserts into the opening of the lower of the shaft base 6, two portions of the articulated shaft 14 respectively inserts into the corresponding shaft bore of the shaft base 6 and the corresponding shaft bore 116 of the main body 114. The fins of the articulated shaft 14 are respectively connected with the shaft base 6, the shaft base 6 is connected with the rear edge of the upper shell 2.

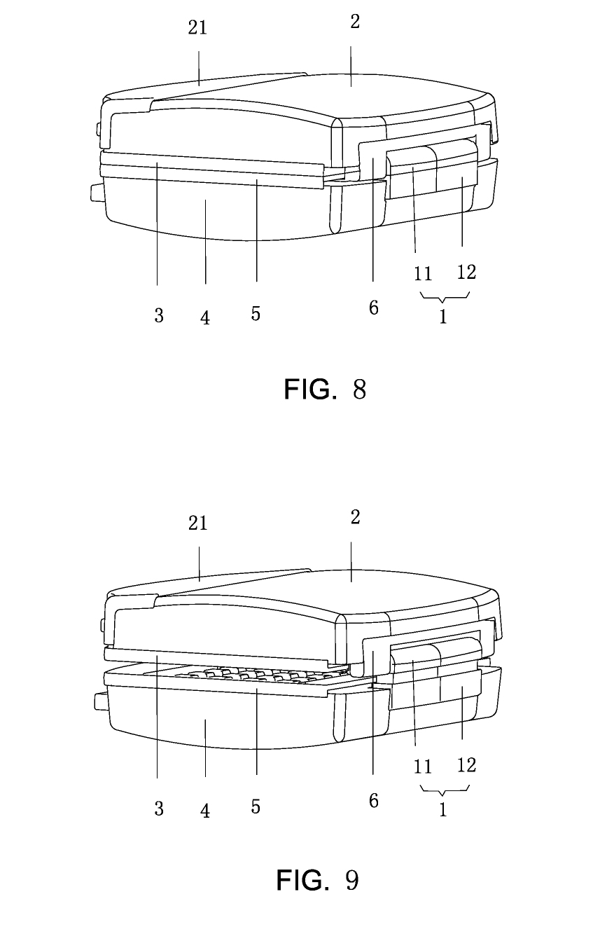

Referring to FIG. 8 and FIG. 9, the shaft base 6 is fixed in the gap of the middle of the rear edge of the upper shell 2. The inserting portion 111 of the shaft sleeve 11 slideably inserts into the inner bore 122 of the main body 121 of the sliding sleeve 12. Two ends of the main body 131 of the limiting sheet 13 respectively slideably inserts into the limiting groove 123 of the main body 121 of the sliding sleeve 12 and the inserting grooves 113 of the inserting portion 111 of the shaft sleeve 11. A screw goes through the bore of the protruding portion 133 of the limiting sheet 13, is fixed on the bottom of the inner groove 112 of the rectangular inserting portion 111 of the shaft sleeve 11, the limiting sheet 13 is fixed with the shaft sleeve 11. Two screws respectively go through the fixing tube 125 of the fixing plate 124 of the sliding sleeve 12, the sliding sleeve 12 is fixed on the gap of the middle of rear edge of the lower shell 4.

Referring to FIG. 8, when the rectangular inserting portion 111 of the shaft sleeve 11 inserts completely into the inner bore 122 of the main body 121 of the sliding sleeve 12, the stop-motion bore 115 is aligned with the corresponding inserting bore 128; the main body 131 of the limiting sheet 13 is positioned on the opening of the limiting groove 123 of the main body 121 of the sliding sleeve 12. When the stop-motion ribs of the lower grill pan insert into the stop-motion bores 115 and the inserting bores 128, the rectangular inserting portion 111 of the shaft sleeve 11 is fixed in the inner bore 122 of the sliding sleeve 12; the articulated shaft 14 of the main body 114 of the shaft sleeve 11 is fixed. The upper shell 2 only can rotates relative to the lower shell 4, food like sandwich is tightly sandwiched between the upper grill pan 3 and the lower grill pan 5 in baking process

Referring to FIG. 9, if move the lower grill pan 5 forwardly, two stop-motion ribs 512 of the lower grill pan 5 go out of two stop-motion bores 115 of the shaft sleeve 11, the stop-motion bores 115 do not take effect, the inserting portion 111 of the shaft sleeve 11 is slidable in the inner bore 122 of the main body 121 of the sliding sleeve 12. The stop-motion bore 115 is not aligned with the corresponding inserting bore 128, when the main body 131 of the limiting sheet 13 reach the bottom of the limiting groove 123 of the main body 121 of the sliding sleeve 12, the limiting sheet 13 stops the shaft sleeve 11 going upwardly, the slide field of the articulated shaft 14 is limited by the slide field of the limiting sheet 13. The upper shell 2 not only can rotates relative to the lower shell 4, but also can freely lift in baking process, satisfy the requirement for baking food like waffle cake, which can not be tightly sandwiched.

As mentioned above, the described embodiments are to be considered in all respects only as illustrative and no restrictive. All changes which come within the meaning and range of equivalency of the claims are to be embraced with their scope.

What is claimed is:

1. A lifting mechanism of grill, an articulated shaft is provided on edge of a upper shell, said articulated shaft covers a shaft sleeve, said shaft sleeve is connected with corresponding edge of a lower shell; wherein an inserting portion which extends along radius is provided on said shaft sleeve; said inserting portion slideably inserts into a sliding sleeve, a stop-motion unit preventing said inserting portion from sliding is provided on said inserting portion; said sliding sleeve is set on edge of the lower shell.

2. The lifting mechanism of grill according to claim 1, wherein said stop-motion unit of the inserting portion is a stop-motion bore which faces the lower grill pan, a corresponding stop-motion rib of the lower grill pan detachly inserts into said stop-motion bore.

3. The lifting mechanism of grill according to claim 2, wherein an inserting bore corresponding to the stop-motion bore of the inserting portion is provided on said sliding sleeve.

4. The lifting mechanism of grill according to claim 1, wherein a limiting component which limits the slide field of the inserting portion is provided between the said inserting portion and the sliding sleeve.

5. The lifting mechanism of grill according to claim 4, wherein said limiting component comprising: a limiting groove positioned on the side wall of the sliding sleeve; a limiting sheet positioned on the inserting portion, said limiting sheet slideably inserts into the limiting groove of the sliding sleeve.

6. The lifting mechanism of grill according to claim 1, wherein a fixing tube and a fixing plate of the raised orientation line are provided on the middle of the sliding sleeve.

7. The lifting mechanism of grill according to claim 2, wherein a limiting component which limits the slide field of the inserting portion is provided between the said inserting portion and the sliding sleeve.

8. The lifting mechanism of grill according to claim 3, wherein a limiting component which limits the slide field of the inserting portion is provided between the said inserting portion and the sliding sleeve.

9. The lifting mechanism of grill according to claim 7, wherein said limiting component comprising: a limiting groove positioned on the side wall of the sliding sleeve; a limiting sheet positioned on the inserting portion, said limiting sheet slideably inserts into the limiting groove of the sliding sleeve.

10. The lifting mechanism of grill according to claim 8, wherein said limiting component comprising: a limiting groove positioned on the side wall of the sliding sleeve; a limiting sheet positioned on the inserting portion, said limiting sheet slideably inserts into the limiting groove of the sliding sleeve.

11. The lifting mechanism of grill according to claim 2, wherein a fixing tube and a fixing plate of the raised orientation line are provided on the middle of the sliding sleeve.

12. The lifting mechanism of grill according to claim 3, wherein a fixing tube and a fixing plate of the raised orientation line are provided on the middle of the sliding sleeve.
